(19) United States
(12) Patent Application Publication
(10) Pub. No.: US 2009/0022238 A1
(43) Pub. Date: Jan. 22, 2009

(54) MB-OFDM system and method for frame boundary detection

(75) Inventor: Yun-Young Kim, Gyeonggi-do (KR)

Correspondence Address: MILLS & ONELLO LLP, ELEVEN BEACON STREET, SUITE 605, BOSTON, MA, 02108, US

(73) Assignee: Samsung Electronics Co., Ltd., Suwon-si (KR)

(21) Appl. No.: 12/218,824

(22) Filed: Jul. 18, 2008

(30) Foreign Application Priority Data
Jul. 20, 2007 (KR) 10-2007-0073091

(51) Int. Cl. H04K 1/10

(52) U.S. Cl. 375/260

(57) ABSTRACT

A method of detecting a frame boundary for a multi-band orthogonal frequency division multiplexing mode is comprised of: calculating an autocorrelation value of a reception signal; estimating an error of the autocorrelation value; and detecting a frame boundary with reference to the error, a sign of the autocorrelation value, and a sign of an autocorrelation value of a previous reception signal. The method is able to substantially exactly detect the frame boundary even when the frequency error rate of all band groups of the UWB spectrums defined by the WiMedia PHY specification is conditioned over ±70 ppm.

### CROSS-REFERENCE TO RELATED APPLICATIONS

This U.S. non-provisional patent application claims priority under 35 U.S.C. §119 of Korean Patent Application No. 10-2007-0073091 filed on Jul. 20, 2007, the entire contents of which are incorporated herein by reference.

### FIELD OF THE INVENTION

The present invention disclosed herein relates to a frame boundary scheme for a multi-band orthogonal frequency division multiplexing (MB-OFDM) mode device.

### BACKGROUND

Wireless personal area network (WPAN) is the technology that enables short-haul communication within around 10 meters (m) among household appliances, mobile devices, and terminals in an ad-hoc network with miniaturation, lower cost, and less power consumption. The IEEE 802.15.3 working group is promoting a WPAN standard that is able to support a maximum data transmission rate of 480 Mega bits per second (Mbps) as a basis of the new physical layer called ultra-wide band (UWB) by Task Group 3a (TG3a).

The MB-OFDM is one of the technical aids for implementing the WPAN standards, dividing a frequency region into plural 528 MHz bands and using the bands by frequency hopping among them.

All operations of a receiver in an MB-OFDM system for high-frequency data transmission normally begin when an initial signal is successfully taken thereat, so it becomes very important to exactly acquire the initial signal.

### SUMMARY OF THE INVENTION

The present invention is directed to a method for detecting a frame boundary in a multi-band orthogonal frequency division multiplexing mode.

The present invention is also directed to an MB-OFDM system capable of accurately acquire an initial signal.

An aspect of the present invention is directed to a method of detecting a frame boundary for a multi-band orthogonal frequency division multiplexing mode. The method is comprised of: calculating an autocorrelation value of a reception signal; estimating an error of the autocorrelation value; and detecting a frame boundary with reference to the error, a sign of the autocorrelation value, and a sign of an autocorrelation value of a previous reception signal.

Estimating the error can be comprised of determining whether the autocorrelation value is included in a first error range.

Determining whether the autocorrelation value is included in the first error range can be comprised of determining if a real part of the autocorrelation value is negative and determining if an absolute value of the real part of the autocorrelation value is larger than an absolute value of an imaginary part of the autocorrelation value.

Detecting the frame boundary can be comprised of detecting the frame boundary based on signs of the real parts of the autocorrelation values of the current and previous reception signals if the autocorrelation value is included in the first error range.

Detecting the frame boundary can be comprised of determining the reception signal as belonging to a frame synchronization sequence when the sign of the real part of the autocorrelation value is complementary to the sign of a real part of the autocorrelation value of the previous reception signal when the autocorrelation value is in the first error range.

Determining whether the autocorrelation value is included in the first error range can be further comprised of determining the autocorrelation value to be in a second error range if the autocorrelation value is outside of the first error range.

Detecting the frame boundary can be further comprised of detecting the frame boundary based on signs of the imaginary parts of the autocorrelation values of the current and previous reception signals if the autocorrelation value is included in the second error range.

Detecting the frame boundary can be further comprised of determining the reception signal as belonging to a frame synchronization sequence when a sign of the imaginary part of the autocorrelation value is complementary to a sign of an imaginary part of the autocorrelation value of the previous reception signal when the autocorrelation value is in the second error range.

The autocorrelation value of the reception signal can be defined by:

$${C}_{b , m} = {\sum }_{k = 1}^{128} {{r}_{b , m} [ k ]}_{b , m - 1}^{*} [ k ]$$

where b, m, and k are positive integers and b is a band number; m is a symbol number; and k is the total number of symbols.

The method can be further comprised of inputting the next reception signal if the frame boundary was not detected using the autocorrelation value of the reception signal; and performing the autocorrelation value calculation for the next reception signal.

The method can be further comprised of storing the autocorrelation value as the autocorrelation value of the previous reception signal if the frame boundary was not detected using the autocorrelation value of the reception signal.

The first error range can be about ±35 ppm (part per million) or less.

According to another aspect of the present invention, provided is a multi-band orthogonal frequency division multiplexing system including: an autocorrelator configured to receive a current reception signal and to output an autocorrelation value; and a detection circuit configured to estimate an error of the autocorrelation value and to detect a frame boundary with reference to the error, a sign of the autocorrelation value, and a sign of an autocorrelation value of a previous reception signal.

The detection circuit can include: a first sign detector configured to generate a first sign signal to represent signs of real parts of the autocorrelation values of the current and previous reception signals if the error is included in a first error range; a second sign detector configured to generate a second sign signal to represent signs of imaginary parts of the autocorrelation values of the current and previous reception signals; and a frame boundary detector configured to receive the first and second sign signals and to generate a frame boundary detection signal.

The first sign detector can be configured to determine that the autocorrelation value is included in the first error range if the real part of the autocorrelation value is negative and an absolute value of the real part of the autocorrelation value is larger than an absolute value of the imaginary part of the autocorrelation value.

The first sign detector can be configured to generate the first sign signal by multiplying the real part of the autocorrelation value by the real part of the autocorrelation value of the previous reception signal if the autocorrelation value is included in the first error range.

The second sign detector can be configured to generate the second sign signal by multiplying the imaginary part of the autocorrelation value by the imaginary part of the autocorrelation value of the previous reception signal.

The frame boundary detector can be configured to activate the frame boundary detection signal if one of the first and second sign signals is a negative.

In accordance with another aspect of the present invention, provided is a method of detecting a frame boundary for a multi-band orthogonal frequency division multiplexing mode, the method comprising: calculating an autocorrelation value of a reception signal; estimating an error of the autocorrelation value, including determining whether the autocorrelation value is included in a first error range of a second error range, including: determining the autocorrelation value to be in the first error range if a real part of the autocorrelation value is negative and an absolute value of the real part of the autocorrelation value is larger than an absolute value of an imaginary part of the autocorrelation value; else determining the autocorrelation value to be in the second error range if the autocorrelation value is not in the first error range; and detecting a frame boundary with reference to the error, a sign of the autocorrelation value, and a sign of an autocorrelation value of a previous reception signal.

Detecting the frame boundary can be comprised of determining the reception signal as belonging to a frame synchronization sequence when the sign of the real part of the autocorrelation value is complementary to a sign of a real part of the autocorrelation value of the previous reception signal when the autocorrelation value is in the first error range.

Detecting the frame boundary can be further comprised of determining the reception signal as belonging to a frame synchronization sequence when a sign of the imaginary part of the autocorrelation value is complementary to a sign of an imaginary part of the autocorrelation value of the previous reception signal when the autocorrelation value is in the second error range.

A further understanding of the nature and advantages of the present invention herein may be realized by reference to the remaining portions of the specification and the attached drawings.

### BRIEF DESCRIPTION OF THE FIGURES

Non-limiting and non-exhaustive embodiments in accordance with the present invention will be described with reference to the following figures, wherein like reference numerals refer to like parts throughout the various figures unless otherwise specified. In the figures:

FIG. 1 shows UWB spectrums;

FIG. 2 shows time-domain preambles for time-frequency codes;

FIG. 3 graphically shows error ranges of autocorrelation values in the packet synchronization sequence period;

FIG. 4 graphically shows error ranges of autocorrelation values in the frame synchronization sequence period;

FIG. 5 graphically shows error ranges of real and imaginary parts involved in the m'th and (m-1)'th autocorrelation values in order to explain a frame boundary detection scheme by a preferred embodiment system and method according to the present invention;

FIG. 6 is a flowchart showing an embodiment of a controlling procedure for detecting a frame boundary in an MB-OFDM receiver according to an aspect of the present invention; and

FIG. 7 is a block diagram showing an embodiment of a receiver of the MB-OFDM system in accordance with an aspect of the present invention.

### DETAILED DESCRIPTION OF PREFERRED EMBODIMENTS

Hereinafter, aspects of the present invention will be described by explaining illustrative embodiments in accordance therewith, with reference to the attached drawings. While describing these embodiments, detailed descriptions of well-known items, functions, or configurations are typically omitted for conciseness. Like reference numerals refer to like elements throughout the accompanying figures.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

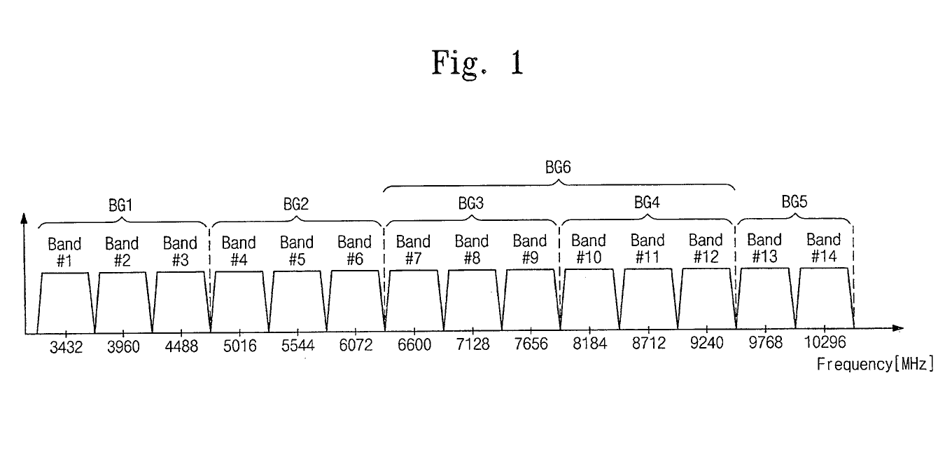

FIG. 1 shows UWB spectrums. Referring to FIG. 1, the UWB spectrums use the frequency band of 3.1˜10.6 GHz. The whole frequency region is divided into fourteen bands, each of which is 528 MHz in bandwidth. The 14 bands are bound in six band groups BG1˜BG6. For example, the kernel frequency f_{c} of a b'th band is defined in Equation 1 below.

f_{c}=2904+528×b [MHz], where b=1, 2, . . . , 14 [Equation 1]

Among the 6 band groups, each of the first four band groups BG1˜BG4 includes three bands, while the fifth band group includes two bands. The last, sixth band group BG6 includes two band groups, e.g., BG3 and BG4.

In and before the WiMedia physical layer (PHY) version 1.1, known in the art, only the first band group BG1 has been mandatorily used, while the other five band groups BG2˜BG6 have only been selectively used in accordance with a type of system involved in the communication. But, from the WiMedia PHY version 1.2, such a mandatory regulation has been removed and systems are now required to support use of all six band groups BG1˜BG6.

As PHY specifications permit the maximum frequency error range to be 20 ppm, a receiver of a UWB device must process frequency errors of ±40 ppm, at a maximum. Under the condition of the maximum frequency error range ±40 ppm, while a band with the kernel frequency of 4,488 MHz permits its frequency error range in ±169.5 kHz, a band with the kernel frequency of 10,296 MHz permits its frequency error range in ±411.8 kHz. In other words, the frequency error range of ±411.8 kHz in the band with the kernel frequency of 10,296 MHz corresponds to the frequency error range of ±91.7 ppm in the band with the kernel frequency of 4,488 MHz. Therefore, for normal operations in accordance with the WiMedia PHY version 1.2 specification and beyond, the receiver must be capable of processing frequency errors up to the range ±91.7 ppm.

In the WiMedia PHY version 1.2 specification, time-frequency codes (TFCs) are utilized to allocate the inherent base sequence S_{b}[k], k ε {1, 2, . . . , 128}. A preamble of a reception signal includes twenty-one packet synchronization sequence symbols (21 PSS-OFDM symbols), three frame synchronization sequence symbols (3 FSS-OFDM symbols), and six channel estimation sequence symbols (6 CES-OFDM symbols).

A preamble sequence Sₙ[k] of the n'th OFDM symbol is defined as follows.

Sₙ[k]=S_{c}[n]Sₑₓₜ[k], n=1, 2, . . . , 30, k=1, 2, . . . , 165 [Equation 2]

S_{c}[n] denotes a cover sequence to the n'th OFDM symbol and Sₑₓₜ[k] denotes a time-domain sequence obtained by padding 37 ‘0’s on the base sequence S_{b}[k].

The cover sequence S_{c}[n] includes the PSS and FSS-OFDM symbols. The PSS and FSS-OFDM symbols have the same magnitude, but are different in sign.

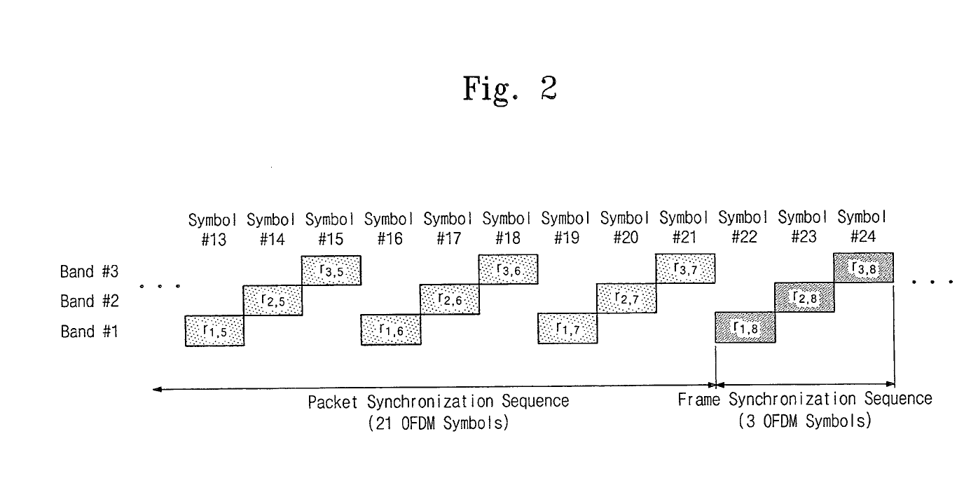

FIG. 2 shows time-domain preambles for the time-frequency code TFC1.

Referring to FIG. 2, the time-frequency code TFC1 has a frequency hopping sequence of {1, 2, 3, 1, 2, 3} in the three bands #1˜#3.

Performing frequency hopping among the three bands for every OFDM symbol, the receiver determines whether there is a frequency-domain signal in the order from the 25'th OFDM symbol (not shown) by detecting a frame boundary from the FSS after executing synchronization in the time domain.

In general, the receiver detects the frame boundary through a correlation between reception signals r_{b,m}[k] and r_{b,m-1}[k], respectively, of the (m-1)'th and m'th OFDM symbols in the b'th band. A correlation value between reception signals r_{b,m}[k] and r_{b,m-1}[k], respectively, of the (m-1)'th and m'th OFDM symbols in the b'th band, C_{b,m}, is given by Equation 3.

$${C}_{b , m} = {\sum }_{k = 1}^{128} {{r}_{b , m} [ k ]}_{b , m - 1}^{*} [ k ] \qquad [ Equation 3 ]$$

In Equation 3, * means a complex conjugate. The PSS is different from the FSS in sign, and real parts of the autocorrelation value are always negative. Thus, the receiver detects the frame boundary by determining the FSS from a point when the real part of the autocorrelation value changes from positive to negative.

Hereinafter will be described with Cₘ as the autocorrelation value C_{b,m}, it should be understood that Cₘ is defined as the autocorrelation value of the reception signals r_{b,m}[k] and r_{b,m-1}[k] included in the same band.

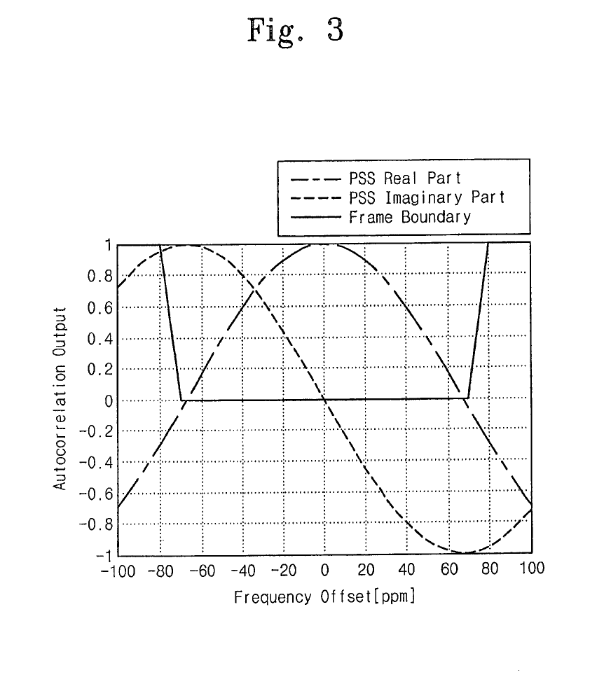

FIG. 3 graphically shows error ranges of autocorrelation values in the PSS period.

Referring to FIG. 3, in the PSS period, the real parts of the autocorrelation value are always positive. But, the real parts of the autocorrelation value change to negative if the frequency error range is over ±70 ppm. When the real parts of the autocorrelation value changes to negative from positive, the receiver of the OFDM system fails to determine that the FSS is input thereto. As a result, the receiver fails to detect the frame boundary.

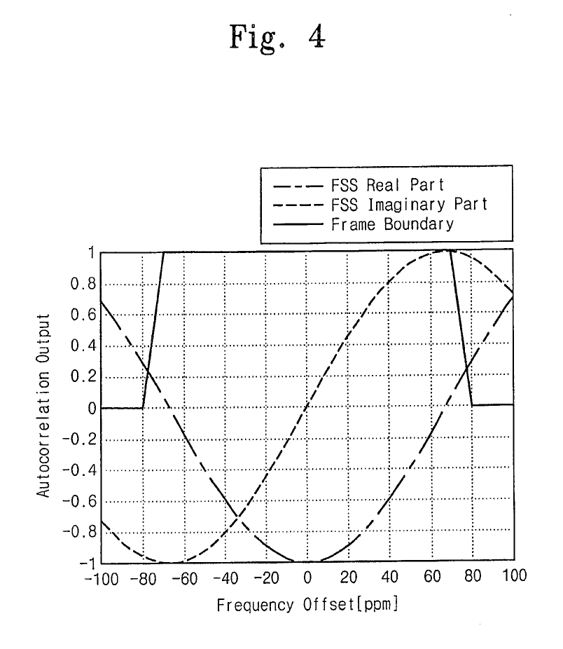

FIG. 4 graphically shows error ranges of autocorrelation values in the FSS period.

Referring to FIG. 4, the real parts of the autocorrelation value must be negative in the FSS period. But, if the frequency error range is beyond ±70 ppm, the real parts of the autocorrelation value to the FSS can become positive. If the real parts of the autocorrelation value become positive, the receiver determines that there is an input of the PSS-OFDM symbols. As a result, the receiver fails to detect the frame boundary. Therefore, it is necessary to provide a scheme for accurately detecting the frame boundary even when the frequency error range of the reception signal is over about ±70 ppm.

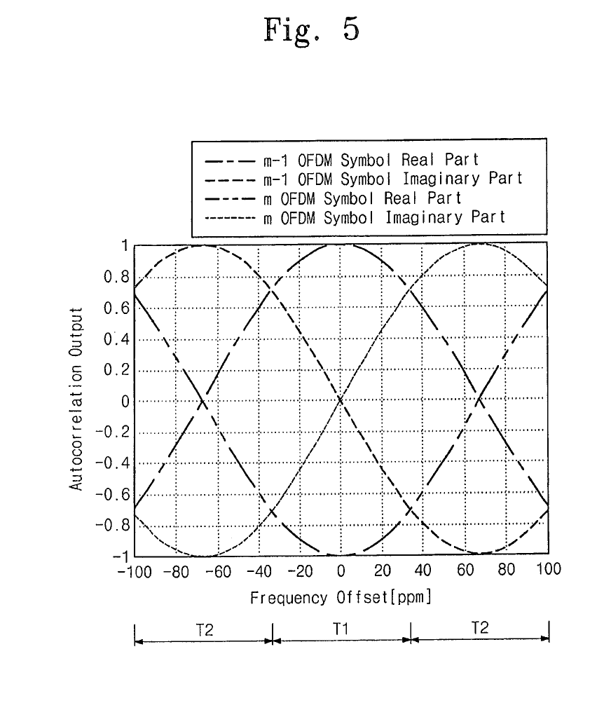

FIG. 5 graphically shows error ranges of the real and imaginary parts involved in the m'th and (m-1)'th autocorrelation values that are useful in explaining the frame boundary detection scheme implemented by a preferred embodiment of a receiver in accordance with the present invention.

As illustrated in FIG. 5, it is possible to plot the frequency error ranges of the real and imaginary parts of the m'th and (m-1)'th autocorrelation values obtained by Equation 3 on a single plane of the same frequency offsets. A smaller frequency error range is referred to as a first error range T1 while the other frequency error range, which is wider than the first error range T1, is referred to as a second error range T2. In the graph of FIG. 5, the first error range T1 is set around ±35 ppm and the second error range T2 is set beyond around ±35 ppm.

The frame boundary can be detected if the (m-1)'th OFDM symbol belongs to the PSS and the m'th OFDM symbol belongs to the FSS. As aforementioned, it can be seen that if the real part Re{Cₘ₋₁} of the (m-1)'th autocorrelation value is positive and the real part Re{Cₘ} of the m'th autocorrelation value is negative, then the (m-1)'th OFDM symbol belongs to the FSS and the m'th OFDM symbol belongs to the FSS.

However, as shown in FIG. 5, if the frequency error range becomes over about ±70 ppm, it is hard to detect whether or not the (m-1)'th OFDM symbol belongs to the FSS and the m'th OFDM symbol belongs to the FSS. Thus, there is a need of providing a new scheme of detecting the frame boundary.

An embodiment of a frame boundary detection scheme according to aspects of the present invention is as follows.

First, the receiver identifies an error range of the autocorrelation value Cₘ for a current reception signal rₘ.

If the real part Re{Cₘ} of the autocorrelation value Cₘ is negative and the absolute value of the real part Re{Cₘ} is larger than that of the imaginary part Im(Cₘ), the autocorrelation value Cₘ for the current reception signal rₘ is determined as being included in the first error range T1. When the autocorrelation value Cₘ is included in the first error range T1, if the real part Re{Cₘ₋₁} of the autocorrelation value for the previous reception signal rₘ₋₁ is complementary in sign to the real part Re{Cₘ} of the autocorrelation value for the current reception signal rₘ, the current reception signal rₘ belongs to the FSS.

When the current reception signal rₘ is included in the first error range T1, a condition for determining the current reception signal rₘ as corresponding to the FSS is given by Equation 4.

Condition 1: Re{Cₘ}<0 & |Re{Cₘ}|>| Im{Cₘ}| & Re{C_{m-1}·}Re{Cₘ}>0 [Equation 4]

That is, when the autocorrelation value Cₘ is included in the first error range T1, the current reception signal rₘ belongs to the FSS if the autocorrelation value Cₘ₋₁ for the previous reception signal rₘ₋₁ is complementary to the autocorrelation value Cₘ for the current reception signal rₘ in sign.

However, when the current reception signal rₘ is out of the first error range T1, a condition for determining the current reception signal rₘ as corresponding to the FSS is given by Equation 5.

Condition 2: Im{Cₘ₋₁} & Im{Cm}<0 [Equation 5]

If neither Condition 1 nor Condition 2 is satisfied, the current reception signal rₘ is irrelevant to the FSS. Namely, the current reception signal rₘ correspondst to the PSS, and not the FSS. Then, the autocorrelation value Cₘ is calculated from the next reception signal and the aforementioned procedure is repeated for discriminating the FSS.

According to aspects of the present invention as described above, the frame boundary can be substantially exactly detected even though the frequency error range of the autocorrelation value Cₘ is over ±70 ppm.

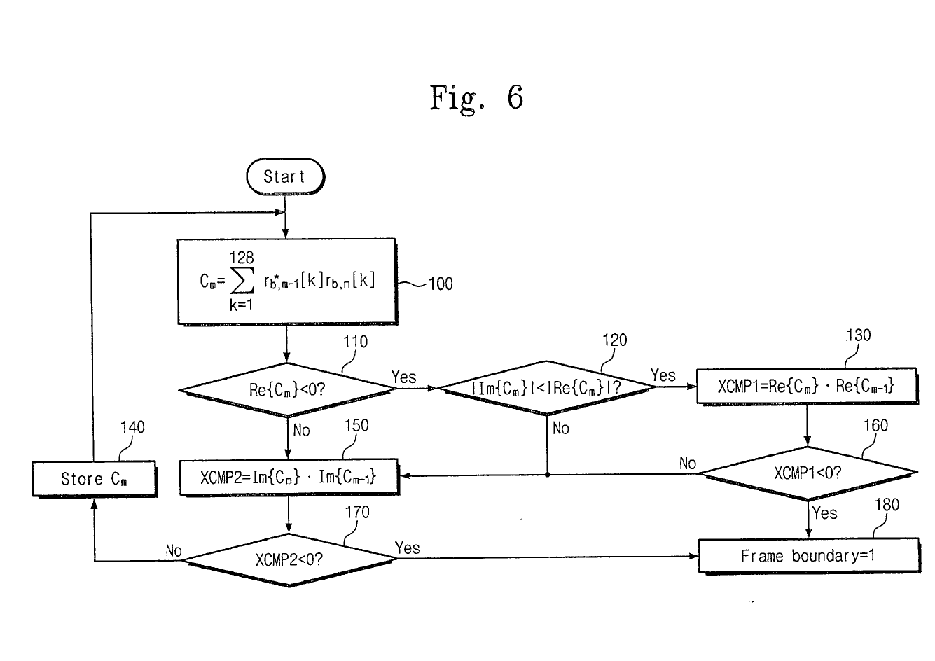

FIG. 6 is a flowchart showing an embodiment of a controlling procedure for detecting the frame boundary in the MB-OFDM receiver according to aspects of the present invention.

Referring to FIG. 6, the receiver accepts the reception signal r_{b,m} that is the m'th OFDM symbol in band b. Then, the receiver calculates the autocorrelation value Cₘ of the current reception signal r_{b,m} and the previous reception signal r_{b,m-1} that is the (m-1)'th OFDM symbol (step 100). The autocorrelation value Cₘ (=C_{b,m}) is obtained by Equation 3.

Next, the receiver discriminates whether the real part Re{Cₘ} of the obtained autocorrelation value Cₘ is negative (step 110). If the real part Re{Cₘ} of the autocorrelation value Cₘ is a negative, the receiver determines whether the absolute value of the real part Re{Cₘ} of the autocorrelation value Cₘ is larger than the absolute value of the imaginary part Im{Cₘ} of the autocorrelation value Cₘ (step 120). If the absolute value of the real part Re{Cₘ} of the autocorrelation value Cₘ is larger than the absolute value of the imaginary part Im{Cₘ} of the autocorrelation value Cₘ, the autocorrelation value Cₘ is regarded as belonging to the first error range T1. Continuously, the real part Re{Cₘ} of the autocorrelation value of the current reception signal r_{b,m} is multiplied by the real part Re{Cₘ₋₁} of the autocorrelation value of the previous reception signal r_{b,m-1}, and a signal XCMP1 is output as a result of the multiplication (step 130).

If the signal XCMP1 is determined to have a negative sign (step 160), then the current reception signal r_{b,m} is discriminated as being included in the FSS and the frame boundary is detected thereby (step 180).

However, if conditions 110, 120, and 160 were not satisfied, the imaginary part Im{Cₘ} of the autocorrelation value of the current reception signal r_{b,m} is multiplied by the imaginary part Im{Cₘ₋₁} of the autocorrelation value of the previous reception signal r_{b,m-1}, and a signal XCMP2 is output as a result of the multiplication (step 150).

If the signal XCMP2 is determined to have a negative sign (step 170), then the current reception signal r_{b,m} is discriminated as being included in the FSS and the frame boundary is detected thereby (step 180). Unless the signal XCMP2 is negative (step 170), the current reception signal r_{b,m} is discriminated as being included in the PSS and the next reception signal is input to the receiver after storing the autocorrelation value Re{Cₘ} of the current reception signal r_{b,m} in, for example, a buffer (step 140).

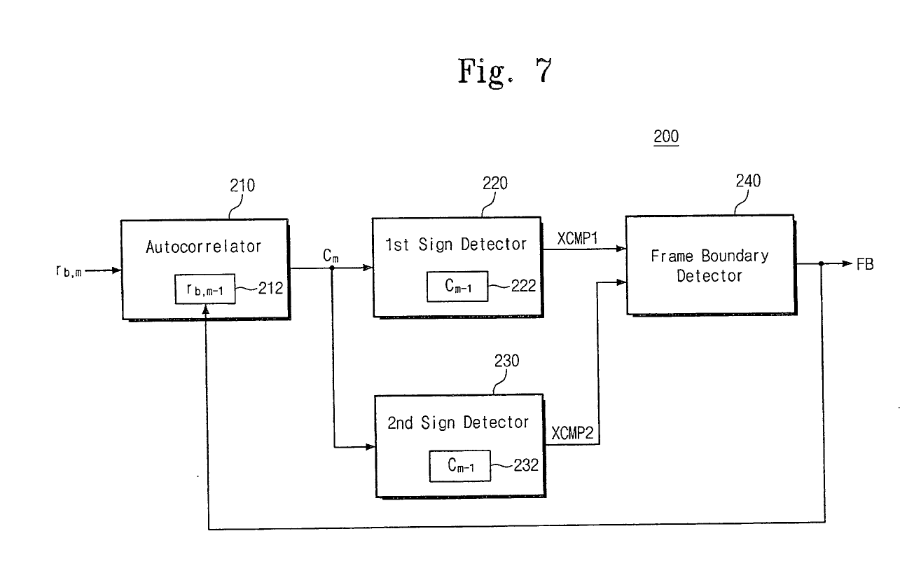

FIG. 7 is a block diagram showing an embodiment of a receiver of an MB-OFDM system, according to aspects of the present invention.

Referring to FIG. 7, the receiver 200 is comprised of an autocorrelator 210, a first sign detector 220, a second sign detector 230, and a frame boundary detector 240. The autocorrelator 210 receives the reception signal r_{b,m} that is the m'th OFDM symbol of the band b, and then calculates the autocorrelation value Cₘ. The autocorrelator 210 includes a buffer 212 for storing the previous reception signal r_{b,m-1} that is the (m-1)'th OFDM symbol of the band b. The first sign detector 220 receives the autocorrelation value Cₘ and then outputs the first sign signal XCMP1. The first sign detector 220 includes a buffer 222 for storing the previous autocorrelation value Cₘ₋₁. The second sign detector 230 receives the autocorrelation value Cₘ and then outputs the second sign signal XCMP2. The second sign detector 230 includes a buffer 232 for storing the previous autocorrelation value Cₘ₋₁. The frame detector 240 outputs a frame boundary detection signal FB in response to the first and second sign signals XCMP1 and XCMP2.

An operation of the receiver shown in FIG. 7 is as follows.

The autocorrelator 210 calculates the autocorrelation value Cₘ between the previous reception signal r_{b,m-1}, which is stored in the buffer 212, and the current reception signal r_{b,m} according to Equation 3.

The first sign detector 220 multiplies the real part Re{Cₘ} of the autocorrelation value of the current reception signal r_{b,m} by the real part Re{Cₘ₋₁} of the autocorrelation value of the previous reception signal r_{b,m-1} and outputs the first sign signal XCMP1, if the real part Re{Cₘ} of the autocorrelation value Cₘ input from the autocorrelator 210 is negative and the real part Re{Cₘ} is larger than the imaginary part Im{Cₘ} in absolute value. The autocorrelation value Cₘ₋₁ of the previous reception signal r_{b,m-1} is obtained by using a value stored in the buffer 222.

In the meantime, the second sign detector 230 multiplies the imaginary part Im{Cₘ} of the autocorrelation value Cₘ, which is input from the autocorrelator 210, by the imaginary part Im{Cₘ₋₁} of the autocorrelation value of the previous reception signal r_{b,m-1}, and outputs the second sign signal XCMP2. The autocorrelation value Cₘ₋₁ of the previous reception signal r_{b,m-1} is obtained by using a value stored in the buffer 232.

The frame boundary detector 240, if one of the first and second sign signals XCMP1 and XCMP2 has a negative sign, discriminates the current reception signal r_{b,m-1} as belonging to the FSS and activates the frame boundary detection signal FB.

The frame boundary detection signal FB is fed back to the autocorrelator 210. The autocorrelator 210 receives the next reception signal r_{b,m} if the frame boundary detection signal FB is inactive, or interrupts its operation of if the frame boundary detection signal FB is active. Therefore, the receiver 200 continues a series of operations for detecting the frame boundary until the frame boundary detection signal FB becomes active.

While the receiver embodiment shown in FIG. 7 is described such that the first and second sign detectors 220 and 230 store the previous autocorrelation value Cₘ₋₁ in their internal buffers 222 and 232, it is also permissible to form the buffers 222 and 232 to only store a sign of the previous autocorrelation value Cₘ₋₁. In other words, if the previous autocorrelation value Cₘ₋₁ has a positive sign, the buffers 222 and 232 store the sign +1. If the previous autocorrelation value Cₘ₋₁ has negative sign, the buffers 222 and 232 store the sign −1. As a result, the sizes of the buffers 222 and 232 can be reduced.

In another embodiment, without including the buffers 222 and 232 in the first and second sign detectors 220 and 230, the autocorrelator 210 may be designed to include a buffer for storing the previous autocorrelation value Cₘ₋₁, which can be shared by the first and second sign detectors.

Meanwhile, the first and second signals XCMP1 and XCMP2 can be designed to be initially set to predetermined positive values, preventing malfunctions of the frame boundary detector 240.

The receiver according to aspects of the present invention is able to substantially exactly detect the frame boundary—even when the frequency error rate of all band groups of the UWB spectrums defined by the WiMedia PHY specification is conditioned over ±70 ppm.

The above-disclosed subject matter is to be considered illustrative, and not restrictive, and the appended claims are intended to cover all modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description or illustrative embodiments disclosed herein.

What is claimed is:

1. A method of detecting a frame boundary for a multi-band orthogonal frequency division multiplexing mode, the method comprising:
calculating an autocorrelation value of a reception signal;
estimating an error of the autocorrelation value; and
detecting a frame boundary with reference to the error, a sign of the autocorrelation value, and a sign of an autocorrelation value of a previous reception signal.

2. The method as set forth in claim 1, wherein estimating the error is comprised of: determining whether the autocorrelation value is included in a first error range.

3. The method as set forth in claim 2, wherein determining whether the autocorrelation value is included in the first error range is comprised of:
determining if a real part of the autocorrelation value is negative; and
determining if an absolute value of the real part of the autocorrelation value is larger than an absolute value of an imaginary part of the autocorrelation value.

4. The method as set forth in claim 3, wherein detecting the frame boundary is comprised of:
detecting the frame boundary based on signs of the real parts of the autocorrelation values of the current and previous reception signals if the autocorrelation value is included in the first error range.

5. The method as set forth in claim 3, wherein detecting the frame boundary is comprised of:
determining the reception signal as belonging to a frame synchronization sequence when the sign of the real part of the autocorrelation value is complementary to a sign of a real part of the autocorrelation value of the previous reception signal when the autocorrelation value is in the first error range.

6. The method as set forth in claim 5, wherein determining whether the autocorrelation value is included in the first error range is further comprised of:
determining the autocorrelation value to be in a second error range if the autocorrelation value is outside of the first error range.

7. The method as set forth in claim 6, wherein detecting the frame boundary is further comprised of:
detecting the frame boundary based on signs of the imaginary parts of the autocorrelation values of the current and previous reception signals if the autocorrelation value is included in the second error range.

8. The method as set forth in claim 6, wherein detecting the frame boundary is further comprised of:
determining the reception signal as belonging to a frame synchronization sequence when a sign of the imaginary part of the autocorrelation value is complementary to a sign of an imaginary part of the autocorrelation value of the previous reception signal when the autocorrelation value is in the second error range.

9. The method as set forth in claim 7, wherein the autocorrelation value of the reception signal is defined by:
$${C}_{b , m} = {\sum }_{k = 1}^{128} {{r}_{b , m} [ k ]}_{b , m - 1}^{*} [ k ]$$
where said b, m, and k are positive integers and said b is a band number; said m is a symbol number; and said k is the total number of symbols.

10. The method as set forth in claim 1, which is further comprised of:
inputting a next reception signal if the frame boundary was not detected using the autocorrelation value of the reception signal; and
performing the autocorrelation value calculation for the next reception signal.

11. The method as set forth in claim 10, which is further comprised of:
storing the autocorrelation value of the reception signal as the autocorrelation value of the previous reception signal if the frame boundary was not detected using the autocorrelation value of the reception signal.

12. The method as set forth in claim 2, wherein the first error range is about ±35 ppm (part per million) or less.

13. A multi-band orthogonal frequency division multiplexing system comprising:
an autocorrelator configured to receive a current reception signal and to output an autocorrelation value; and
a detection circuit configured to estimate an error of the autocorrelation value and to detect a frame boundary with reference to the error, a sign of the autocorrelation value, and a sign of an autocorrelation value of a previous reception signal.

14. The multi-band orthogonal frequency division multiplexing system as set forth in claim 13, wherein the detection circuit comprises:
a first sign detector configured to generate a first sign signal to represent signs of real parts of the autocorrelation values of the current and previous reception signals if the error is included in a first error range;
a second sign detector configured to generate a second sign signal to represent signs of imaginary parts of the autocorrelation values of the current and previous reception signals; and
a frame boundary detector configured to receive the first and second sign signals and to generate a frame boundary detection signal.

15. The multi-band orthogonal frequency division multiplexing system as set forth in claim 14, wherein the first sign detector is configured to determine that the autocorrelation value is included in the first error range if an absolute value the real part of the autocorrelation value is a negative and an absolute value of the real part of the autocorrelation value is larger than the imaginary part of the autocorrelation value.

16. The multi-band orthogonal frequency division multiplexing system as set forth in claim 13, wherein the first sign detector is configured to generate the first sign signal by multiplying the real part of the autocorrelation value by the real part of the autocorrelation value of the previous reception signal if the autocorrelation value is included in the first error range.

17. The multi-band orthogonal frequency division multiplexing system as set forth in claim 16, wherein the second sign detector is configured to generate the second sign signal by multiplying the imaginary part of the autocorrelation value by the imaginary part of the autocorrelation value of the previous reception signal.

18. The multi-band orthogonal frequency division multiplexing system as set forth in claim 17, wherein the frame boundary detector is configured to activate the frame boundary detection signal if one of the first and second sign signals is negative.

19. A method of detecting a frame boundary for a multi-band orthogonal frequency division multiplexing mode, the method comprising:
calculating an autocorrelation value of a reception signal;
estimating an error of the autocorrelation value, including determining whether the autocorrelation value is included in a first error range of a second error range, including:
determining the autocorrelation value to be in the first error range if a real part of the autocorrelation value is negative and an absolute value of the real part of the autocorrelation value is larger than an absolute value of an imaginary part of the autocorrelation value; else
determining the autocorrelation value to be in the second error range if the autocorrelation value is not in the first error range; and
detecting a frame boundary with reference to the error, a sign of the autocorrelation value, and a sign of an autocorrelation value of a previous reception signal.

20. The method as set forth in claim 19, wherein detecting the frame boundary is comprised of:
determining the reception signal as belonging to a frame synchronization sequence when the sign of the real part of the autocorrelation value is complementary to a sign of a real part of the autocorrelation value of the previous reception signal when the autocorrelation value is in the first error range.

21. The method as set forth in claim 19, wherein detecting the frame boundary is further comprised of:
determining the reception signal as belonging to a frame synchronization sequence when a sign of the imaginary part of the autocorrelation value is complementary to a sign of an imaginary part of the autocorrelation value of the previous reception signal when the autocorrelation value is in the second error range.
